(19) United States
(12) Patent Application Publication
(10) Pub. No.: US 2007/0129123 A1
(43) Pub. Date: Jun. 7, 2007

(54) System and method for game creation

(76) Inventors: Robert Eryou, Victoria (CA); Charles Denis Melanson, Lincoln (CA)

Correspondence Address: BENNETT JONES LLP, 3400 ONE FIRST CANADIAN PLACE, PO BOX 130, TORONTO, ON, M5X 1A4, CA

(21) Appl. No.: 11/293,022

(22) Filed: Dec. 2, 2005

(51) Int. Cl. A63F 13/00

(52) U.S. Cl. 463/1; 463/16; 463/42

(57) ABSTRACT

A game system and method that involves game creation through a dynamic or other Human Computer Interface that provides one or more “tools” used to define a game structure and associated rules. Community tools are created by participants or provided for enhancing peer collaboration, communication, validation, interactions, socialization and other connections in the community space that is defined around the game creation tools. Gaming is supported through execution of the game instructions as defined by any user acting as game creator and by the participants either in advance or in a real-time basis.

### BACKGROUND OF THE INVENTION

Gaming is a critical and growing market segment. In particular, online games are some of the broadest and most diverse category of games currently available including games such as poker, backgammon, multi-user dungeon (MUD), massively-multi player role playing games (MMORPGs), massively multiplayer online games (MMOG)., fantasy sports games, kids games and other games. Online games can position the player against a computer or a player against other peer players or even a combination of computer and peer players. The uniqueness of games in the online space is that the games become a sort of meeting place for diverse individuals to come together to share a common “virtual” space for specific game play. Unfortunately, when a person tires of playing a particular game or desires to play a different type of game, whether as a result of boredom, moving on to a new game, terminating a subscription or otherwise, they often lose an opportunity to act with people that they have met. Furthermore, even if you do stay in contact, it is often difficult to get the same players to move on to a new shared game or find them in the new game-based community in which they may move.

Part of this difficulty is based on access: sometimes users will only know each other by gaming “handles” (nicknames in a gaming space) and may not know each other's actual identities. This is a good thing with respect to privacy and anonymity but is a bad thing from a purely social perspective. For this reason, there is a need for a community space that more closely resembles how people socialize, play games and interact to begin games and during game play in society.

The prior art does provide some tools for such spaces such as proprietary software interfaces that permit collective “launch” and community tools that allow some players to find each other. The problems with these tools are that 1) they are almost always proprietary; 2) all users must share the same application or they will often not communicate; and 3) such solutions will often only support specific games 4) they almost always offer a static proprietary game structure which limit the player's game experience to the specific constraints of the current game. In other words, while there are some tools that can be used as a gaming launch pad and community space, there exists a need for a method and system that can be used by players to create non-proprietary, interactive games which foster social relationships in a true gaming community by replicating human nature with reference to game play.

### SUMMARY OF THE INVENTION

The present invention provides an improved method of game play by enabling the creation and development of dynamic gaming environments that: permit the development of gaming “systems” and rules by individual users, that permit engagement of those environments through use of normal IM, email, wireless (wifi, gprs, gsm, sms, mms, etc.) or browser-based and other network communication technologies, that permit the aggregation of users in gaming “communities” and that support peer validation, reputation and trust models (either direct trust or indirect trust through a directly trusted intermediary) that permit users to safely engage in gaming activities with related communities through chains of trust.

The most fundamental aspect of this invention relates to the development of a gaming platform that is non-proprietary in its rules or structures. As mentioned above, there are numerous proprietary structures that have been developed that, within the narrow framework of that structure, permit a certain amount of development by users. The current invention shifts the entire gaming convention by permitting the users themselves to develop the STRUCTURE OF THE GAME. This is a crucial distinction as it means that the very rules and boundaries of gaming performance can be defined dynamically and it will permit users to create a huge diversity of rich gaming environments in which players can be invited to participate. The primary method for permitting this flexibility is a toolkit of conditions, functions, events, data feeds, awards (monetary, points based), secondary or bonus conditions, and additional (new or derivative) gaming toolkits which a user is invited to apply to create the gaming “structure” as desired.

An embodiment of this invention can be most easily illustrated with reference to gambling and betting types of games. For example, a game could be generated based on event triggers and the game could involve allocating points to an outcome associated with that user-generated event. In the simplest case, this would be an either/or condition such as betting whether a person in the office would keep their job or whether a certain personal objective would be achieved. In more complex cases, the event could generate multiple outcomes such as when a pregnant co-worker would have the baby (could be specific dates, date ranges, before/after, etc). In the event that a game creator has influence over the game outcome, a new and unique method of game play is employed. In game theory, the optimal solution to a zero sum game (i.e. binary betting) is to find the minimax of the outcome calculated from the payoff matrix. In other words, the game creator can calculate the best payoff based on various outcomes over which they have influence. To prevent unfair game play of this nature, a new and unique game type called “zero sum with blind payoff” is used to ensure the game creator cannot calculate the minimax and therefore artificially influence the outcome in their favor. In this case, the payoff calculation of the game is not revealed to the creator and/or players thereby preventing the minimax calculation advantage. Some of these personal games may involved objective verification while others may require subjective verification and could include further functionality for posting results or outcome proofs (such as images, video or external references), a community voting process for validating the game result or proof through participants in the game or through impartial judgment by the participating/volunteering peers in a social gaming community as a whole. Then points, awards, money or whatever consideration is being distributed (as defined by the dynamic game rules) can be distributed to the appropriate “winners” of the game.

In various embodiments of the invention, the gaming system may be mapped into a community and/or trust based model that permits individual users to connect with other users that they can invite to participate in their games. The community of gaming users may also participate in larger social production model where community based assessment or community based play policing may occur. This could include online “smart mobs”-spontaneous peer connections/clustering based on dynamic game creation (flock towards a game system based on game content or game rules, etc.) Community driven game structures are also able to collaborate to create socially interesting games. This is similar in concept to the blog websites (such as tribe.com) that permit friend lists and other connections to be made so that information or content can be shared. In this instance, it would involve invites to participate in games that have been constructed in this environment. This community model could also be extended to include indirect friend (within a certain number of “degrees” of connection) invites or invites to people that have participated in certain games types or communities in the past. For example, if someone elected to construct a game related to sports outcomes, an invite could be sent to prior members of similar gaming constructs. Another possibility is to permit members of the game to invite other participants and “validate” their participation. This could be an invite that permits participation without further validation or the validation would create liability on the part of the inviting party as a check against invites to players that would otherwise not step up to any obligations (community peer judgments) (in the case of a gambling site with real money involved, for example). Finally, the party that wishes to join without an invite could do so only after providing further assurances of commitment to the game such as a minimum number of visits, financial escrow, or other factor.

Additionally, a search function could be provided that permits any member of the public or just members of a “trusted community” to access and join a game. The search function could be implemented using a standard search function, such as the functions offered by Google™, a pull down menu, even group links to permit search browsing or a method of game content clustering (game content/rules are grouped based on several factors). An additional enhancement to the search function could include personalization such as ranking based on former game participation, preferred communities, or other factors that can be collected based on a user interaction with the gaming communities.

With respect to a gaming embodiment that is based on gambling game concepts, an additional embodiment that can be embedded into search or just general use functions is a scoring system that rates probabilities, bet histories or other factors that might provide the user with insight into the estimated likelihood of betting success. For example, a user may wish to bet on a gambling game that provides a very high payout and lower probability or instead may desire to have a bet on a more “sure thing” that increases the likelihood of winning.

Constructed games could be connected based on shared factors or construction enabling creation of super pools or other sorts of collective systems that provide a larger community “base” for the game. For example, a gaming system based on a condition, such as the outcomes of an college basketball tournament, could be combined to create a super pool based on sharing the ENTIRE pool or enabling pooling based on only a portion of the consideration. For example, 90% of the pool could be maintained on a “private” based while 10% is contributed to a global pool. Any numbers of configurations are possible based o shared attributes of game construction.

Finally, participation could be anonymous or provided via proxy (which permits new private pools to be based on the outcome of a previously constructed game) or other gaming outcomes as specified in the construction of the game.

### BRIEF DESCRIPTION OF THE FIGURES

FIG. 1 is a sample gaming template for creating a reality betting game.

FIG. 2 is a flow chart illustrating the basic method of game creation either with or without a template.

FIG. 3 is a sample log-in screen that could be used to log in to a personalized dashboard.

FIG. 4 is a sample dashboard interface.

FIG. 5 is a sample flowchart for creating a reality betting game

FIG. 6 is a community/peer validation method for game results/proofs

### DETAILED DESCRIPTION OF THE PREFERRED EMBODIMENT(S)

The present invention provides an improved method of game play by enabling the creation and development of dynamic gaming environments that permit: the development of gaming “systems” and rules by individual users, engagement of those environments through use of normal IM, email, browser-based, wireless (wifi, gprs, gsm, sms, mms, etc.) and other network communication technologies, the aggregation of users in gaming “communities” and that support validation, reputation (positive and/or negative), and trust models (either direct trust or indirect trust through a directly trusted intermediary) that permit users to safely engage in gaming activities with related communities through chains of trust. Additionally, various mechanisms are provided that permit games to leverage off of the results of other games (derivative games or ladder games), point or reward allocation based on performance, based on either/or type outcomes, based on probabilities (either calculated or provided) or any number of other reward systems.

The most fundamental aspect of this invention relates to the development of a gaming platform that is non-proprietary in its rules or structures. As mentioned above, there are numerous proprietary structures that have been developed that, within the narrow framework of that structure, permit a certain amount of game development by users and adjustments or tweaks to pre-established rules. The current invention shifts the entire gaming convention by permitting the users themselves to develop the STRUCTURE OF THE GAME itself. This is a crucial distinction as it means that the very rules and boundaries of gaming performance can be defined dynamically and it will permit users to create a huge diversity of rich environments in which players can be invited to participate.

The primary method for permitting this flexibility is a toolkit of conditions, functions, events, data feeds, awards (monetary, points based), secondary or bonus conditions and other game development tools which a user is invited to apply to create the gaming “structure” as desired. The toolkit can also be extended by user interaction, user development or basing game rules/constraints on other games or external references. In the preferred embodiment, the toolkit would be presented in much the same way that existing human computer interface technologies and other personalization tools are used. These types of tools are well-known in the art. What is not well-known in the art, however, is the application of these personalization tools to a method for creating and/or enhancing gaming systems.

Game Creation

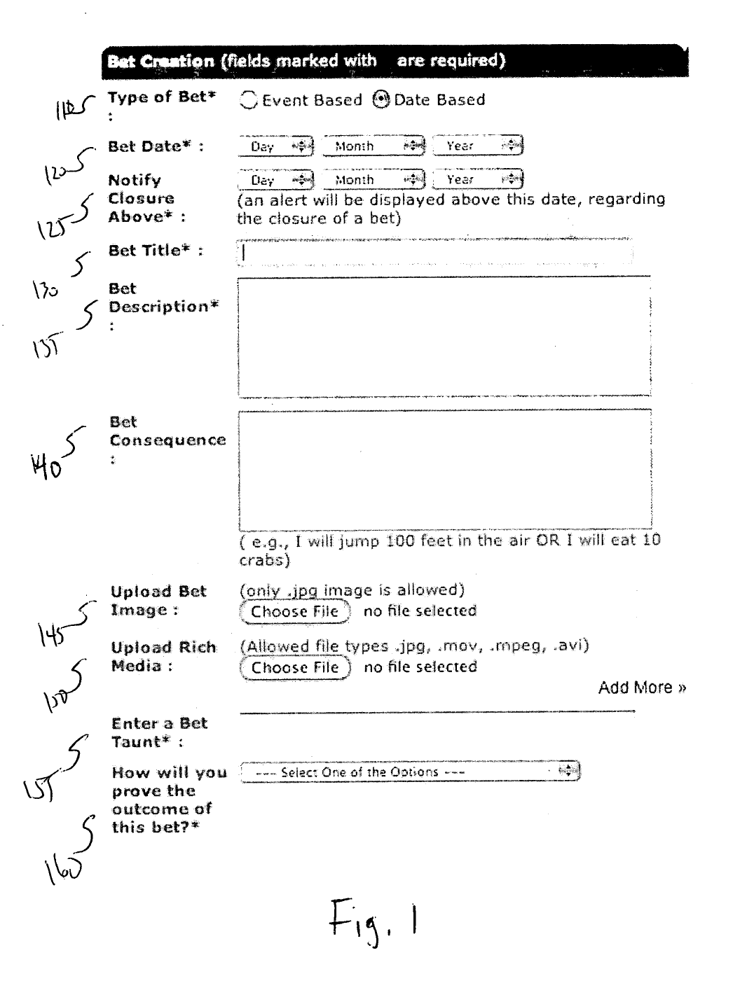

One form of interface used to permit personalization is via pull-down menus and text boxes. In this embodiment, the user is provided with a game “template” and is allowed to modify various aspects of the template in order to create a game. Referring now to FIG. 1, a sample embodiment of such a template interface is illustrated. The present illustration is related to a “gambling” template which can be used to create betting type games. In this simple example, the user is first provided with an opportunity to select a TYPE 110 of bet. The two types 110 provided include an event based event or a date based event. Whether with a bet or in connection with any other game template, selection of a field may result in a revision to later fields or menus that would be available to reflect the attributes required to complete that type 110 of bet or game. In this example, a date based bet is selected so a bet date option is presented for completion. The user could then proceed to complete various attributes of the game/bet including what the bet date 120 would be, whether the bet will be closed on a certain date 125, the title 130 of the bet, a description 135 of the bet, the consequence 140 (what happens if the bet is successful), an image that can be used to illustrate aspects of the bet 145, rich media content 150 (such as videos), a taunt 155 or tagline, and the process for proving the bet outcome 160. It should be noted that while different aspects have been illustrated using either a pull down menu, selection process or a text box, any number of other embodiments may be used such as a drag and drop box or interface or other dynamic structures. While most of these elements are fairly self-explanatory, a brief explanation of each field is provided below:

Each BET can be one of two types 110:
DATE BASED: The bet ends on a specific date. (choose the Date 120) The NASDAQ will rise to 12,000 before Apr. 29, 2005)
EVENT BASED: The task has been completed or some attempt has been made. [I will jump 20′ on my snowboard]

Next, the user would fill out the bet details:
BET TITLE 130: such as “I WILL JUMP 20 Feet on my snowboard”
BET DESCRIPTION 135: In this instance, the user might define what the best is and how you will do it.
BET CONSEQUENCE 140: (optional) If the user wants to add some spice to the bet. This is a personal consequence if they do not meet the bet condition. [I will jump 20′ on my snowboard OR I will put snow on my face]
IMAGE OR MEDIA UPLOADS 145, 150: The user can uploads images or movie files to make your bet intro. If the user bets that he can jump 20′ on his snowboard, he can upload images of snowboarding or jumping 19′ on his snowboard to get people excited/interested in the bet.
BET TAUNTS 155: A small line which will go with the bet—the user can use this to invite other people to the bet. For example, a user might want to say “I'm the greatest snowboarder in history!”
HOW WILL YOU PROVE THE BET 160: When the bet has been completed according to the bet description and profile, this is the proof. For example, it could be by media evidence in which case they can upload an image or movie of the user performing the 20′ snowboard jump. The process of proving a bet may involve all members of the bet voting to agree on the final result or may also include a selected mediator that decides whether the condition has been met. In the case of more objective type bets, this could also involve a data feed or other source from the net that is available to the system. For example, if the bet involved whether the NASDAQ would reach a certain number by a certain date, the process of proving the bet could be provided by a data feed fro Nasdaq.com or some other financial site. Some of these feeds would be provided for free while others could be provided for a fixed fee or some other means of consideration (viewers, bet enrollees, advertisements, etc).

In addition to these basic functions, the bet or any other game could also include “tags” or other descriptors that could flag the bet for interested parties. These could be based on a pre-established list of descriptors, they could be user created descriptors, or they could be descriptors generated by a bot or other automated search and define process (ala Google).

Of course, no game or bet would be complete without some form of consideration. This could be included in the bet creation process (as a standard bet amount), a standard number of points that could be granted for a win based on game type, a standard number of points based on entrants, or it could be provided dynamically by a player upon entry into the game or bet. In one embodiment, each player is provided with a number of “points” upon registration and can use those points to enter games, enroll in bets, or otherwise spend them on various items on the site. These points or token could then be bet dynamically (I bet 2 points that he is right) or it could be a bet against a pre-established pool so that you can ONLY bet a fixed number of points (20 points bet he is right and up to 20 may be bet that he is wrong). Finally, the best could be a dynamic process in which the “bounty” resulting from the bet would be proportional to the pool on the other side. A similar process occurs at casinos in which gamblers can place bets in a horse and the more money bet on the horse lowers the payout in the event of a win. Any number of variations on this theme are possible as the important thing is to understand that “consideration” tools will be provided that provide any number of different ways to collect, distribute, award and otherwise move consideration among and between players based on either final or interim gaming outcomes.

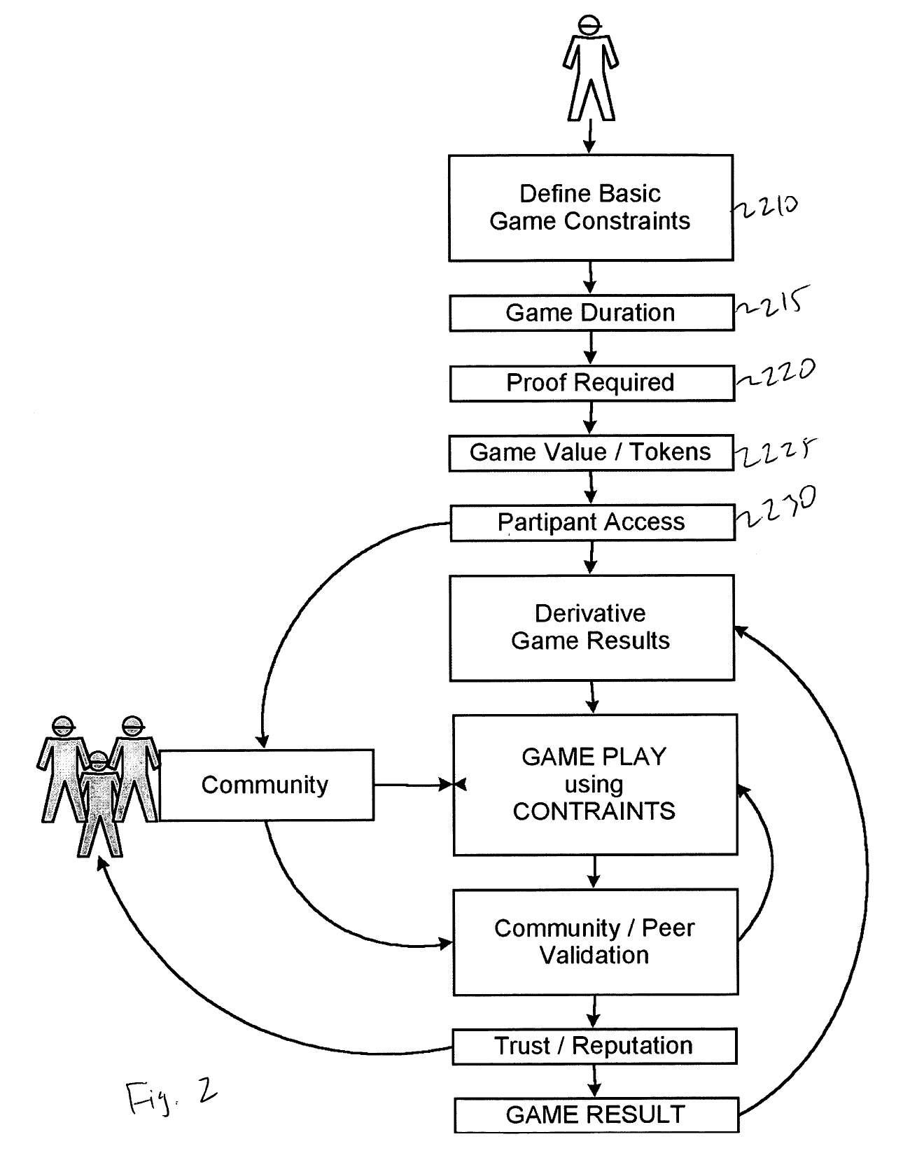

Referring not to FIG. 2, a method for the generic development of games using the present system is provided. As an initial matter, a type of game is selected 210. If the user selects a game that has a pre-established template then the template is provided 215. If the user selects a game without a template, then the user is provided 215 with access to one or more toolboxes. In either case, a user is presented with one or more tools for creating a game type.

The example provided in FIG. 1 represented one such gaming “template”. In that example, the game type was a “bet” and the template provided standard forms, pull downs and other items associated with a personal bet. In other words, the game type was bet but it could be further subdivided into the category: reality betting. Again, using categories of this type can be helpful in flagging the game for users that may be interested in reality betting.

In an alternative embodiment, a more dynamic game type is selected. For example, let us presume that the user selected a dice game type. This game type may come with certain templates that were created to support standard dice game rules and types and permit editing/revision or a generic set of “dice game” tools may be provided.

Regardless of the type of game selected, the user will need to define or agree on the initiation of the game 220. How and when will it start? For example, it could be based on dates in the case of a reality betting game or it could be based on presence or involvement in the case of more dynamic games (start as soon as 4 are “in” the game at the same time or start as soon as at least ten have registered to play).

Once the game initiation conditions have been defined 220, the user must select 225 the next steps in the game. This could involve multiple steps but at the minimum it will involve the defining of an end condition. In the bet reality example, there may be no other condition beyond agreeing to the size of the bet with the end condition being event based (if the condition of the bet is met at some point prior to termination) or time (if terminated based on a date). In the bet reality example, the user would simply designate that the game would end as soon as a condition is met (such as a date with a fellow employee before the end of the month) and if that condition is met those that bet for that event will be paid or the date will be reached without a date being reported meaning that the bet against side would win. Again, the bet condition would be defined based on objective data (which could be inserted by dragging a defined data object on to the bet reality template) or a subjective factor that is provided by the game creator. Additionally, a final condition of the game would also involve distributing consideration to the participants. Again, this can be all or nothing, it could be distributed evenly among the winners, or any other method of “point” distribution. Once again, a tool could be “dropped” on to the template and the tools could provide any number of distribution methods.

In more complex games, the user could select 225 multiple steps. For example, the first step may involve selecting the player to go first or general player order. Preferably, such basic steps would be provided as an option for the user to designate. In a dice game, it might involve the steps of selecting player order though random selection and ordering the players accordingly. It would then involve providing an interface that allows the first player to roll the dice. Again, depending on the rules of the game (first to roll a 12 for example) the game could be very quick or could last several rounds. The die values may be used cumulatively, the die could be rolled more than once, etc. Again, the variations on how one could play the game could be endless as the gaming “toolbox” (and additional gaming or sub-game templates) could be built to support any number of different connectors and tools. In one embodiment, these various steps would be literally connected on a visual interface so that the user can visually see where and how the game would flow and even simulate a turn or game to verify internal consistency.

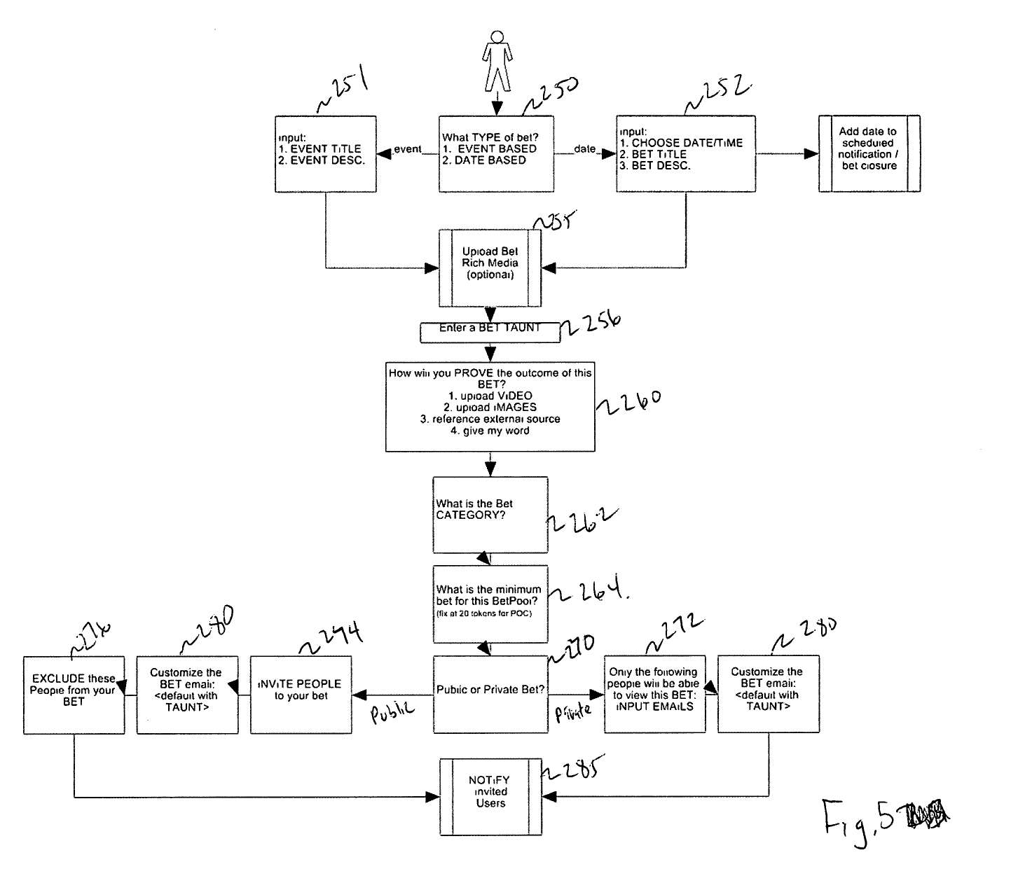

FIG. 5 provides a more detailed flowchart for creating a betting game. In this more detailed example, a type 250 of betting game is selected and results in one or more additional input steps 251, 252. The user is then offered the opportunity to upload rich media for the bet 255 and if desired a taunt 256. The next step is user selection of a validation method 260. This would preferably be provided via a validation model that permits validation using video, images, external sources or based on user reputation (or a minimum threshold of tokens or other community status-gold status for paying subscribers, or subscribers that have been members for a minimum amount of time, or participated in a minimum number of bets etc). The user could then categorize the bet 262 and set betting minimums 264. Finally, the user can determine if they want to make it a private or public bet. This determination would then result (as applicable) in a restricted user list or password selection 272, public invitations 274 and exclusions 276 but in both cases would include preparation and distribution of an email that would default with the bet taunt. The users selected for invitation would then be sent 285 the message.

Game Play

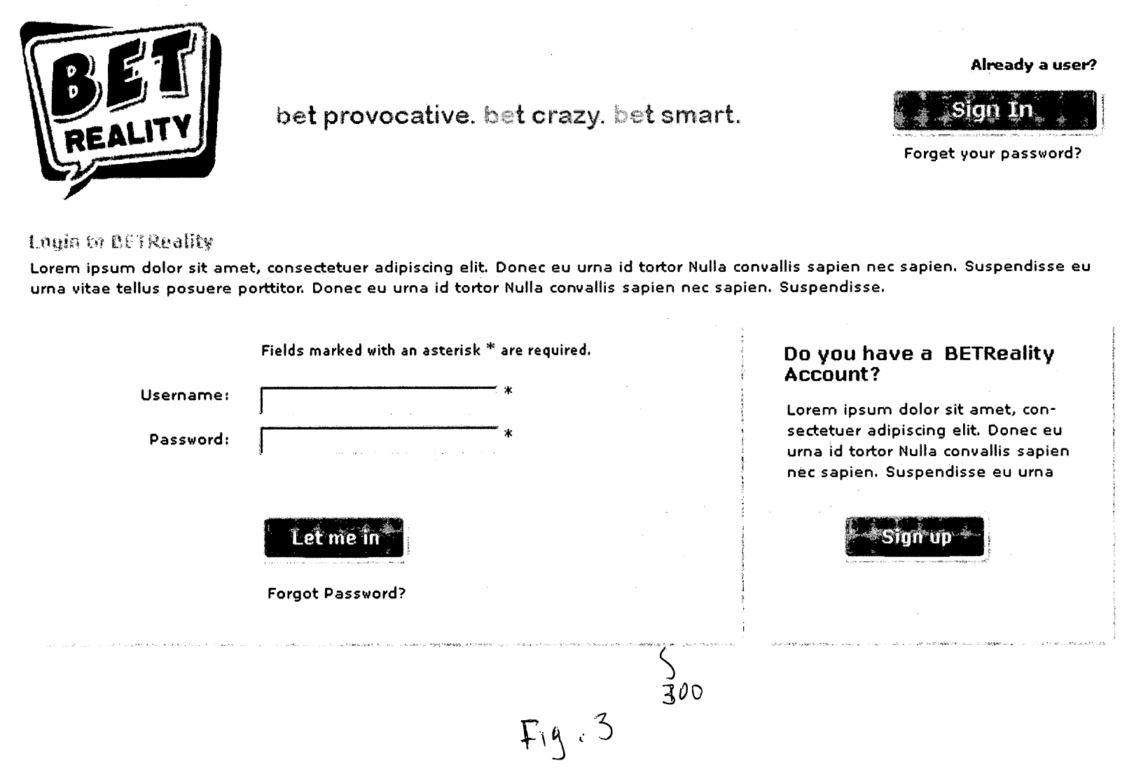

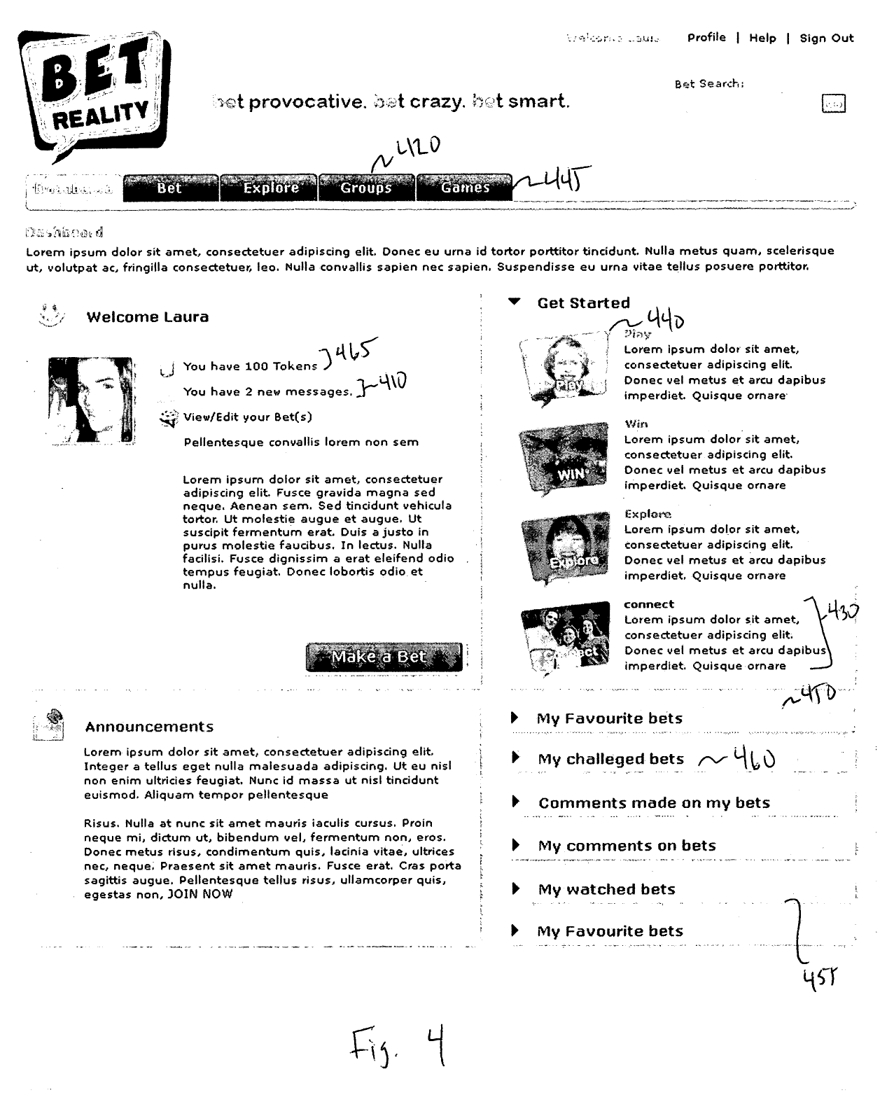

Once the games have been created, the game play would simply involve signing up, showing up or registering for a game that interests you or that you know about. A sample log-in screenshot that can be used to provide this functionality and a sample dashboard is provided in FIGS. 3 and 4. In the preferred embodiment, in addition to providing basic log-in functionality (FIG. 3 300), a gamer would be linked to one or more friends (via email 410, groups or other connecting options 430 and could browse games being hosted by friends, by game type, by game content or other members of their community via play options 440 or a games tab 445, they could search for games based on the attributes of the game (dice based games), they could identify the most popular games (in the bet reality concept, it might involve a list of all of the most popular bets, favorite bets 450, watched bets 455, challenged bets 460), or they could simply browse through available games. Once a game is identified, the person could simply join the game (or request to join the game) and participate in the game. Preferably, each game player would have an allocation of points, chips or tokens 465 (or, if permitted, cash or cash equivalent) that could also be used to make the games more interesting and provide a “leader board” or other functionality for identifying the best players across each of the games or the most popular bets. As explained above, in the case of a reality betting game, the person could put a fixed number of these “points” on to the outcome of the bet when joining that game and would be paid based on the number of points bet on the opposite side of the bet—on a pro-rata basis or some other payout methodology.

In addition to playing games directly, a player could also be permitted to participate in the game vicariously. For example, two players could engage in a card game for points while yet other players were betting on the outcome of the game, while still yet other players were betting on the outcome of how many people would bet on the event itself. Effectively, this would create games based on games. Players could elect to bet points directly on these outcomes or even more options—such as bluffing—could also be permitted. For example, in one embodiment of the reality betting template, bluffing would be permitted when betting on an outcome so that it may appear that more funds are being placed for or against an outcome that is actually true. These sorts of options would preferably be selected (so that each player has an opportunity to guess the bluff) at game creation. Again, it is important to understand that any number of variations on gameplay and creation or possible within this framework with the core issue being the creation and development of game models, winning conditions, point allocations, and direct and indirect involvement in gaming models.

In the preferred embodiment, playing games would require tokens or some other consideration so preferably a user would be provided with an opportunity to replenish their credits or tokens in the event that they were lost during game play. A user account module would store tokens, provide additional allotments, permit conversion from one form of credit or consideration to another and could also permit monetary subscriptions and other activities that enable a user to get access to more (or different types of) tokens. This module could include a token routine for generating a base allotment of tokens upon registration, allot tokens based on levels of play (i.e. higher levels based on more participation or based on a monetary subscription or other purchase), or it could change allotments based on barter (including using cash or non-cash consideration) such as selling benefits or game creations to (or between) players (or other community benefits) in exchange for tokens. The user account module could also take account of the range of other community beneficial activities that can be connected directly or indirectly to a given user and therefore provide additional tokens or other credits accordingly.

Reputation

One of the important features of any gaming community is reputation. Reputation is important for creating trusted friend networks and enhancing involvement in gaming systems. As a result, the gaming system disclosed herein would preferably support various reputation models that would permit users to trust users either directly (such as through a friends list, an IM list, or other trusted network relations) or indirectly (friends of friends or reputation points). Two models are relevant and would preferably be applied to this sort of gaming system. First, eBay™ has a reputation model that permits users that have bought or sold products from other users to rate their experience. This is the indirect model as it means you rely on the experience of others (as reported online) for determining whether a given vendor is trustworthy. This has become an incredibly powerful tool for eBay™ as trust is a critical commodity for encouraging interactions among strangers. In the gaming setting, rather than rating people based on products, the reputation would be based on either the objective or subjective quality of game play (i.e. did they quit, did they cheat, did they complete the game, were they good?) or it could also be based on the quality of games created. In other words, the other users help measure the quality of your interactions with the gaming system either as a player or as a creator. The second model is the “friends” model such as the one used on tribe.net. In this model, a user is “trusted” if they are within X degrees of a person that you know. So a friend of a friend could be in but someone that is more than three degrees away (friend of a friend of a friend) may be too attenuated.

Regardless of the model used, reputation can be used as a tool to limit game involvement, to initiate invites, to meet new players, to provide additional tokens for game play etc. In other words, the reputation can be used in any number of ways (or simply as a learning tool) in connection with game play. A player's network of friends (particularly invited friends) could also impact the amount and number of tokens given to the player based on the activities of friends on the network (more tokens for more friend driven involvement or other beneficial community activities that can be linked or otherwise related in some way to the player.

Validation

Because game creation is dynamic and game creators may base rules and outcomes on events that are not verifiable outside the community, a peer or community validation system may be employed. The spirit of the validation model is to provide a method and means for the game players or the community as a whole (game players need not be included) to act as judges or validators for the game outcome or proof. In this manner, the judgment could be a community voting system in a democratic fashion to review the game and outcome and decide on a winner(s). Selection of validation may come from a volunteer model, an automatic choice of all players in the game, an automatic choice of all players not in the game, or a threshold scheme whereby the number of validators required to complete the validation stage is based on a percentage of of participants or the community or other threshold variations. The validation can be linked to a reputation score for any type of game role; game creator, game players, community of players etc. In the validation-reputation model, select roles may be positively or negatively assessed by the community judgments to determine fair game outcome, fair game play, fair game creation etc.

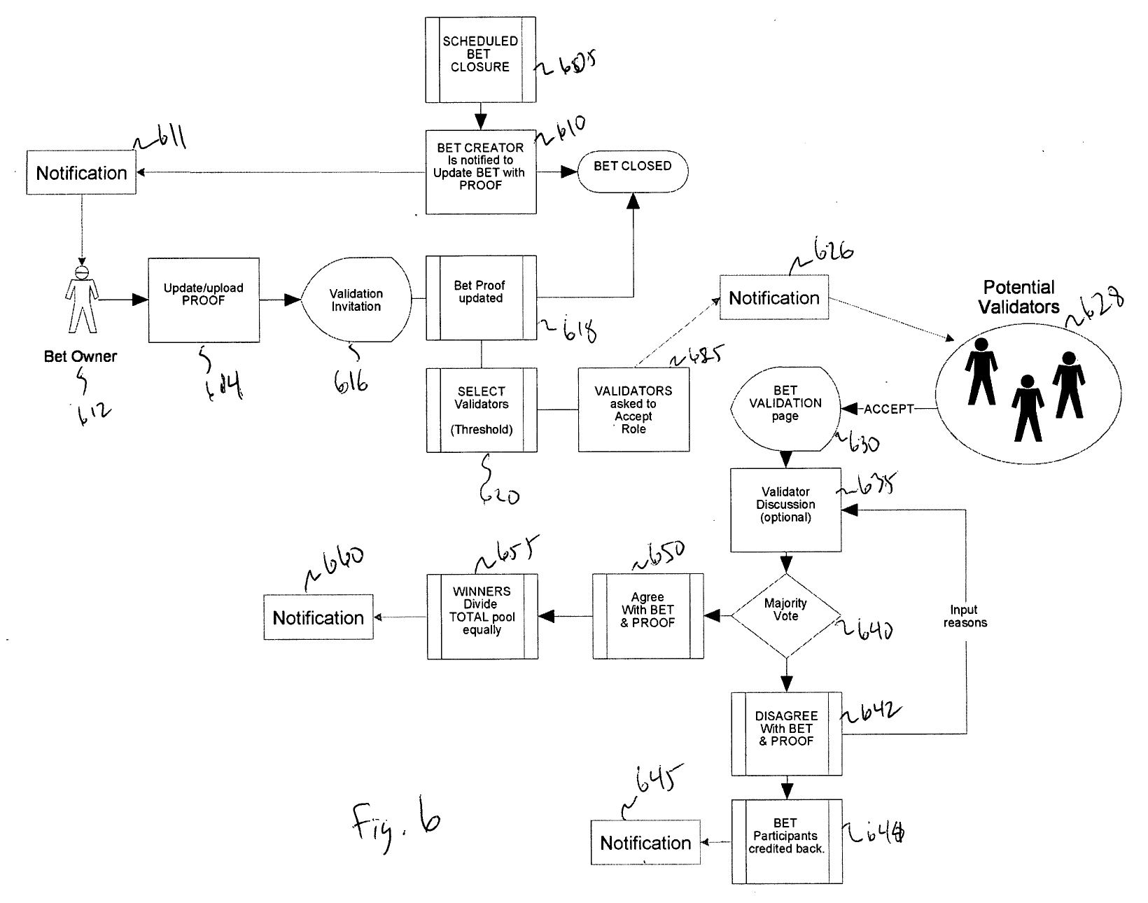

A brief overview of this Process is defined with reference to FIG. 6. Once a schedule bet reaches closure 605, the bet owner 612 is sent a notification 611 to update the bet with the results of the bet (proof) 610. The bet owner 612 uploads proof 614 and the bet proof is updated 618. As stated above, the bet owner 612 may then elect to validate the bet by drafting an invitation 616 and inviting all members of the bet or some of selection of validators 620 (either within the bet or external to it) to validate the bet result. This invitation 616 and selection 620 could also follow validation criteria provided during bet creation. One or more potential validators 628 are then asked to accept this role 625 and through a notification 626. If they accept, then they are given a link or some other access to a bet validation page 630. An optional tool is a discussion or other electronic communication means that allows the validators 628 to discuss 635 the bet. If no conclusion can be reached based on a majority vote 640, then the bet proof is disqualified 642 and the bet participants are credited 640 back any consideration (such as tokens) and a notification 645 is sent. If the majority 640 of validators 628 agree with bet and proof 650, then the winners are provided with a portion of the divided pool based on the type of payout methodology selected (equal parts is shown) and are sent a notification 660 accordingly.

Community

The reputation tools and other methods for measuring the quality of differing users all relates to the creation and development of community. A community is a group of people having similar interests. So the community model as applied to the present invention would mean provision of tools that allow individuals with similar interests to share and help support each other in those interests. Communities may be open to all (public) or closed based on membership/reputation/etc. Additionally, communities may have leaders or facilitators or may simply be a free for all. Tools and Their Roles Community-building tools include, but not limited to, email, Newgroups/Blogs/Weblogs/Feeds(RSS), chat/Instant Messanger, message boards, client/server software, Mobile Devices/Mobile Networks, peer-to-peer networks and API/Webservices.

Email:

An email list, sometimes called a Listserv, after the Listserv™ software which often used to run email lists, is a community tool which connects people via email messages. There is one central address to which everyone sends messages for the group, and from there the email is sent out to all subscribers. A person receiving the mail has the choice to respond either to the sender individually, or to the whole list. Digest forms are often available for people who prefer to get one or more longer emails with lots of messages in it rather than each individual post as it arrives. Email lists are sometimes moderated, meaning each post is approved by a moderator, or the list owner, before it is sent out. Some web-based community-building systems include email tools to mail everyone in your group, as well as the ability to create sub-group mailing lists and send newsletters. In the game setting, such an email could also be triggered based on scheduled events, the notification of a gaming related event (such as a condition being met in the reality betting game template) or any number of other reasons. Some community software has a feature called “topic subscription” which allows people to participate in conferencing via email. They receive the posts in their mailbox rather than signing onto a website.

Newgroups/Blogs/Weblogs/Feeds:

Newgroups/Blogs/Weblogs/Feeds are like a cross between public message boards and an email list. Users have to subscribe to a newsgroup/blog, and sometimes only subscribers or authors can post a message. They are usually not moderated. To read newsgroup messages, a user may need a newsgroup/blog (RSS) reader. Often these come with browser (like Netscape Messenger) or your email software (Microsoft Outlook) or specialized Blog/RSS readers (Netnewswire) or consumed by other data services (News and search agreegators: Google, Technorati etc.). In the gaming setting, users would subscribe to the newsgroup/news feed, download the “headers,” or title lines, and then can read and interact as they choose.

Chat/Instant Messenger:

Chat/Instant Messenger is simultaneous communication by people who are online at the same time and typing messages or sharing files or data with each other. Chat can be done in public rooms, open to anyone, or private rooms where only those of the community can enter. Chat is usually, but not always, a many-to-many communication mode—in other words, there are a group of people in a room at once, conversing. It can also be used for one-to-one meetings, brainstorm sessions and other game-oriented applications including co-development of more tools or collections of tools. It's also possible online to use software to send “live” or “instant” messages to one particular user. This is more traditionally a one-to-one communication tool or one to a select group of several (some IM tools support multiple invites into a single chat space).

Message Boards/Conferencing:

Message board software online is much like a message board in an office: you post a message on the board and come back an hour, a day, or a week later to see if anyone has responded to it. Therefore, message board communication is asynchronous—all participants don't have to be online at the same time. Message boards are also sometimes called “forums” or “conferencing.” There are two ways to organize messages in a message board system: threaded and linear. Threaded means that subjects are kept in a single “thread” while linear are simple messages that are shared based on time. Obviously, different message boards (and the volume of posting) will determine which model is more appropriate. For example, boards that are meant to facilitate real-time game involvement would preferably be time based. For general discussion around say game creation, a threaded board would be more appropriate.

In addition to more active communication tools, the community space would also preferably include places in which game creators could share game combinations, rule twists or other more “complex” assemblages that have been created. Sharing and generating such tools can greatly accelerate development by other gamer creators as they can take earlier game creations and make small mods to the rules without having to re-create it from scratch. Other sorts of files could also be shared including images (such as game board images or backgrounds), videos, how to files, etc. In other words, the community space could be facilitated by a shared file cabinet in which creative tools can be shared.

Client/Server:

Traditional client server model can be employed to facilitate a hosted game model for players. Each game creator can use the system to create the game and “host” it on a centralized server. Each game player can participate by connecting to the centralized server to participate in the game. Examples of technologies are HTML, XHTML served with web or specialized application servers to a thin client such as an Internet browser or specialized client.

Mobile Devices/Mobile Networks:

Any mobile device capable of sending/receiving data by connection to a synchronous or asynchronous network infrastructure can create or participate in game play using native.

Peer to Peer Networks:

Direct peer game play is possible through a decentralized communication model. Using known peer to peer transport methods and topologies, a game creator could make a game based on peer to peer messaging or even peer activity such as; connection states, connection velocity, connection frequency, random selection, peer calculation tasks, peer participation tasks, peer ratios etc.

Application Programming Interface/API/Web Services:

In one usage, a user created game structure may be exposed to an open or closed group by means of an machine-to-machine interface. These interfaces are typically used for developing automated software processes that interact with remote systems. In this usage, the user created game structures, rules, triggers and events would be exposed by way of a remote procedure call (examples of usage would be SOAP, RPC, REST, dCOM, DDC etc.). Remote software systems could be developed to enroll, create, play or even extended to create a new game or a derivative game based on any number of existing games or their outcomes.

It should also be noted that game creation or participation can be a hybrid of any type of connectivity or client access device. A player may connect via a mobile device to a gateway which then connects to a centralized web server to facilitate players interconnecting via diverse networks and devices. In one possible embodiment, the proposed system may act as an intermediary 'gateway' for disparate games—enabling games of different types to interact; this would be the case in a derivative game structure or a game based on the results of an external source. Bi-directional game structures may be developed whereby each game is reliant on the progress or outcome of the other.

Other Tools

In addition to community tools, the preferred embodiment of the present gaming system would further include robust search tools for enabling users to find games, find users/players, or otherwise find resources needed to support gaming-related activities. As mentioned above, search tools could include simple key word search technology (such as the search tools provided by Google™), indexing based on content/user/game type/popularity, or any number of other methods.

The social element of the game also combines players in a manual or automated means by linking players through the social network based on peer knowledge, peer interaction, game type or game content.

In addition to search tools that are provided for users, search technology could be used to help build out a “dashboard” for users when they log in. Referring now to FIG. 4, a sample dashboard is shown. In this example, the user is involved with “reality betting” games and is provided with a special page built for users that like to play such games. The user is provided with a log-in area 410 for entering usemame and password. Even before the user has logged in, however, various games are presented that would likely interest a general player of reality betting games—top bets 420, random bets 430, and most popular bets 440 are all examples of “search results” that could help build a dashboard page. Once the user logs in, the interface could be further enhances to focus on the particular types of reality bets that the user prefers based on profiles and other information collected by the gaming system based on prior user interactions. Such a profiling system is used on Amazon™, for example, with respect to books but no one has applied it to the diverse world of gaming as a shared “language” to describe games has never been provided and therefore linking one form of game with another is not as closely related as book or movie types. One of the unique attributes of the present invention is that it finally provides a shared lexicon through the tools used to build the games and the data and content feeds that may be linked into the games. For example, a player may be presented with all games that include bets that involve sports data feeds as a component of the game. Alternatively, they may prefer to participate in reality betting games involving friends or employees that are subjective (office pools and associated betting games) Again, any number of variations is possible given the unique attributes of the present invention.

As the description illustrates, the present invention is extremely powerful in the context of game and community building and provides functions that, while well-known in the prior art with respect to some embodiments, are very unique as extensions of a new way of building game and community. In particular, the ability to create and define new methods of gaming permits more powerful communities, a reputation model, search tools, social interactions, personal preferences and other aspects of online gaming which have otherwise been proprietary and limited to more commercial definitions of games. By handing the power of game creation back to users, the current model supports the brilliance of human ingenuity and creativity. Furthermore, it permits the creation and participation in games that are personal (such as with the reality betting game model) because they involve people you know, events that may involve the player (such as bets on the timing of delivery of a baby, firings, hirings, or other personally verified events) and these make the game system far more compelling and engaging. One need only see the explosion in fantasy gaming and tourney office pools to appreciate that playing games is simply more fun when it has a personal flavor to it. By creating a robust platform for creating and participating in these games, the present invention enhances community and participation around gaming in a manner that is revolutionary. For this reason, while a number of examples have been provided to demonstrate one embodiment of the invention (using web pages and basic browser-based tools) any number of tools or software may be used individually or collectively to accomplish these goals including but not limited to television gaming, mobile device gaming or any mechanism that enables users to communicate. Therefore, the present invention should not be strictly limited to these embodiments but shall instead be defined by the scope of the claims set forth herein.

I claim:

1) A method for enabling the creation online games comprising the steps of:
Providing a list of available types of games that can be created;
Providing configuration controls that permit a user to define at least one rule associated with the enrollment of one or more players into the game;
Providing a selection of starting conditions for the game;
Providing a list of end game condition(s) wherein such list of end game condition is associated with the type of game selected; and
Providing one or more tools for determining whether the end game condition has been met.

2) The method of claim 1, wherein the provision of a list of game types includes fantasy sport game type.

3) The method of claim wherein, wherein the provision of a list of available game types includes betting type games.

4) The method of claim 3, wherein the provision of a betting type game is further refined by subjective and objective betting game types.

5) The method of claim 4, wherein the method further includes providing a validation module for validating the results of a bet.

6) The method of claim 1, further comprising the step of:
providing one or more gaming templates associated with the selection of a game type;
defining at least one attribute provided within such retrieved template responsive to user input.

7) The method of claim 6, wherein the step of retrieving a gaming template includes retrieving templates that have had their attributes defined by a user.

8) A system for enabling the playing of online games comprising:
A registration module for registering a user to the game system,
a game creation module that includes at least one template for defining a game including start, end and one or more game play parameters;
a game access interface that permits user access to the created game using a network connected device;
a user account module that keeps track of the number of tokens or other consideration that may be used by a user to join a game;
a validation module for validating game results; and
a notification module for notifying participants of game results.

9) The system of claim 8, wherein the game creation module includes a template that supports the creation of a reality betting game.

10) The system of claim 8, wherein the game creation module includes a template that supports the creation of a fantasy sports game.

11) The system of claim 8, wherein the game access interface provides an interface for game play via mobile computing devices.

12) The system of claim 8, wherein the game access interface provides an interface for game play via mobile gaming devices.

13) The system of claim 8, wherein the game access interface provides an interface for game play via personal computers.

14) The system of claim 8, wherein the game access interface provides an interface for game play via cellular phone devices.

15) The system of claim 8, wherein the user account module includes an initial allotment of tokens that are provided to a user upon registration.

16) The system of claim 8, wherein the user account module includes a weekly allotment of tokens that are provided to a user.

17) The system of claim 16, further comprising a reputation module for generating a reputation score.

18) The system of claim 17, wherein the reputation module generates a reputation score based on the number of times a user plays a game.

19) The system of claim 17, wherein the reputation module generates a reputation score based on the average reputation score provided by one or more distinct users.

20) The system of claim 17, wherein the weekly allotment of tokens within the user account module is adjusted based on the reputation score of the user.

21) The system of claim 17, such system further comprising a friends module for permitting the identification and management of one or more friends.

22) The system of claim 8, further comprising a game security module for restricting access to a created game.

23) The system of claim 21, wherein the game security module includes a software invitation routine for inviting one or more users to the game.

24) The system of claim 22, wherein the game security module only permits one or more users that have been invited using the invitation routine.

25) The system of claim 8, wherein the game security module for restricting access to a created game only permits users that have a minimum number of tokens stored by the user account module.

25) The system of claim 17, further comprising a game security module for restricting access to games using a reputations score.

26) The system of claim 25, wherein the game security module includes a field for storing a minimum reputation score.

27) The system of claim 8, wherein the game validation module includes a routine for storing one or more bet proofs.

28) The system of claim 27, wherein the bet proofs comprise visual media content.

29) The system of claim 8, wherein the game validation module includes a voting routine for permitting a vote by one or more validators.
